(19) United States
(12) Patent Application Publication
(10) Pub. No.: US 2026/0025787 A1
(43) Pub. Date: Jan. 22, 2026

(54) SYSTEM

(71) Applicant: TOYOTA JIDOSHA KABUSHIKI KAISHA, Toyota-shi (JP)

(72) Inventors: Hiroto NAKAGAWA, Nagoya-shi (JP); Koichi SUZUKI, Miyoshi-shi (JP); Kazuya OKADA, Tokyo (JP)

(73) Assignee: TOYOTA JIDOSHA KABUSHIKI KAISHA, Toyota-shi (JP)

(21) Appl. No.: 19/269,877

(22) Filed: Jul. 15, 2025

(30) Foreign Application Priority Data
Jul. 22, 2024 (JP) 2024-117230

(51) Int. Cl. H04W 64/00; H04W 4/48; H04W 52/02

(52) U.S. Cl. CPC H04W 64/00; H04W 4/48; H04W 52/0229

(57) ABSTRACT

A system, for communicating with a first terminal and a second terminal different from the first terminal, comprises a controller comprising at least one processor configured to perform: receiving, from the first terminal, a search request that is information requesting to search for a position of the second terminal; transmitting a first signal that is a signal to cause the second terminal to enter a wake-up state when the search request is received; detecting the position of the second terminal that has entered the wake-up state; transmitting position information indicating the detected position of the second terminal to the first terminal.

### CROSS REFERENCE TO THE RELATED APPLICATION

This application claims the benefit of Japanese Patent Application No. 2024-117230, filed on Jul. 22, 2024, which is hereby incorporated by reference herein in its entirety.

### BACKGROUND

### Technical Field

The present disclosure relates to sensing of a terminal.

### Description of Related Art

There is a technique for guiding the position of a vehicle parked by a user. In this regard, for example, Japanese Patent Laid-Open-2007-226484A discloses a map distribution server, etc., which identifies the current position and the parking position of the vehicle, generates a guide map by synthesizing the position corresponding to the vertical direction of the current position and the parking position on the map, and provides the guide map to the user. Japanese Patent Laid-Open 2006-275520A also discloses related art.

### SUMMARY

The purpose of this disclosure is to acquire information indicating a position of a terminal to be searched for.

One aspect of an embodiment of the present disclosure is a system, for communicating with a first terminal and a second terminal different from the first terminal, comprising a controller comprising at least one processor configured to perform:
receiving, from the first terminal, a search request that is information requesting to search for a position of the second terminal;
transmitting a first signal that is a signal to cause the second terminal to enter a wake-up state when the search request is received;
detecting the position of the second terminal that has entered the wake-up state;
transmitting position information indicating the detected position of the second terminal to first terminal.

Other aspects include a program for causing a computer to execute an information processing method executed by the system described above, or a computer-readable storage medium in which the program is stored non-transitorily.

According to the present disclosure, it is possible to acquire information indicating the position of the terminal to be searched.

### BRIEF DESCRIPTION OF THE DRAWINGS

FIG. 1 is a diagram illustrating an overview of the processing performed by the system according to the first embodiment.

FIG. 2 is a diagram illustrating the components that make up the fifth-generation mobile communication system (5G network).

FIG. 3A to 3C are diagrams illustrating the components of each device that realizes the system according to the first embodiment.

FIG. 4 is a sequence diagram illustrating a processing executed by the system according to the first embodiment.

FIG. 5 is a sequence diagram illustrating a processing executed by the system according to the second embodiment.

FIG. 6 is a sequence diagram illustrating a processing executed by the system according to the third embodiment.

### DESCRIPTION OF THE EMBODIMENTS

### Overview

In large commercial and other facilities, there is technology that guides the user to the parking position of the user's vehicle.

For example, as a prior art, an information processing apparatus is known to generate a guide map by synthesizing a user's current position and a position corresponding to the vertical direction of the parking position. The information processing apparatus generates a guide map for assisting the user in understanding the relationship between the current position and the parking position by projecting the user's parking position on the floor where the user exists, such as in a commercial facility.

However, in the prior art, when the user's current position and the parking position in which the vehicle is parked exist on different floors of the facility, it is not possible to provide specific guidance on the path that the user should follow from the current position to reaching the parking position.

In order to provide specific guidance on the route to be followed from the user's current position to the point of reaching the parking position, it is conceivable that the core network in a 5G wireless communication system or the like will inform the user of the location of the terminal installed in the vehicle by utilizing sensing technology executed by the core network to the terminal (the “UE”).

In this case, when sensing the position of UE by the core network, the target UE may not be in the activated state. For example, if UE is an in-vehicle device installed in the vehicle, it may be that the in-vehicle device is in a sleep state with the vehicle system.

Therefore, before sensing the target terminal to identify the parking position, the core network sends a signal to the terminal to activate the terminal.

The present disclosure in its one aspect provides a system, for communicating with a first terminal and a second terminal different from the first terminal, comprising a controller comprising at least one processor configured to perform:
receiving, from the first terminal, a search request that is information requesting to search for a position of the second terminal;
transmitting a first signal that is a signal to cause the second terminal to enter a wake-up state when the search request is received;
detecting the position of the second terminal that has entered the wake-up state;
transmitting position information indicating the detected position of the second terminal to first terminal.

The first terminal is, for example, an electronic device such as a smartphone. The first terminal may be a tablet terminal, a personal computer, or a wearable terminal. The first terminal is carried by the user.

The second terminal is, for example, a communication device installed in the vehicle. The second terminal provides a wireless communication function so that the vehicle can communicate with an external network. Or the second terminal may be an in-vehicle terminal for providing functions such as a car navigation system. The second terminal is provided in the parked user's vehicle.

The search request is information transmitted from the first terminal to the control unit requesting searching for the position of the second terminal; the search request may include information requesting route guidance to the position where the second terminal exists.

The first signal is a signal to cause the second terminal to enter a wake-up state, which is transmitted by the control unit to the second terminal, wherein the wake-up state means that the second terminal becomes an activated state. The first signal may be broadcasted from the control unit.

The system, according to one aspect of the present disclosure, transmits a signal to cause the second terminal to enter an activated state, detects the position of the second terminal in the activated state, and notifies the first terminal of the position of the second terminal when information is received requesting to search for the position of the second terminal.

According to such a configuration, the system according to the present disclosure may acquire information indicating the position of the terminal to be searched even if the terminal to be searched for is in a sleep state. As described above, the system according to the present disclosure may acquire the position of the terminal to be searched, thereby realizing a specific guidance display or the like of a route to be traced to the position of the terminal to be searched.

Further, the controller may receive the position information indicating a position of the second terminal transmitted by the second terminal after entering the wake-up state.

This enables the system according to an aspect of the present disclosure to acquire information indicating the position of the second terminal and provide it to the first terminal.

Further, the second terminal may be an in-vehicle terminal installed in a vehicle, and the controller may cause the second terminal to periodically transmit a beacon signal that the first terminal can receive after the second terminal enters the wake-up state.

A beacon signal is a wireless signal transmitted directly from the second terminal to the first terminal. For example, the first terminal may receive a beacon signal transmitted by the second terminal and identify a position of the second terminal based on the beacon signal.

Further, the controller may receive, from the first terminal, ID information indicating an identifier of the second terminal; identify the second terminal based on the received ID information and transmit the first signal to the identified the second terminal.

Accordingly, the system according to one aspect of the present disclosure may identify the second terminal based on an identifier of the second terminal and cause the second terminal to be activated.

Further, the controller may receive a sensing result that is a result of sensing of the second terminal in the wake-up state an object surrounding the second terminal and further transmit the sensing result to the first terminal.

For example, the system according to one aspect of the present disclosure acquires not only the result of sensing the position of the second terminal, but also the result of sensing the surroundings by the second terminal from the second terminal. According to such a configuration, the system according to one aspect of the present disclosure can acquire information indicating a situation around the second terminal. For example, by acquiring said information, additional information indicating what is around the second terminal can be acquired.

Hereinafter, a specific embodiment of the present disclosure will be explained based on the drawings. The hardware configuration, module configuration, functional configuration, etc. described in each embodiment are not intended to limit the technical scope of the disclosure to those only unless otherwise stated.

### First Embodiment

### [Overview of the Processing Executed by the System]

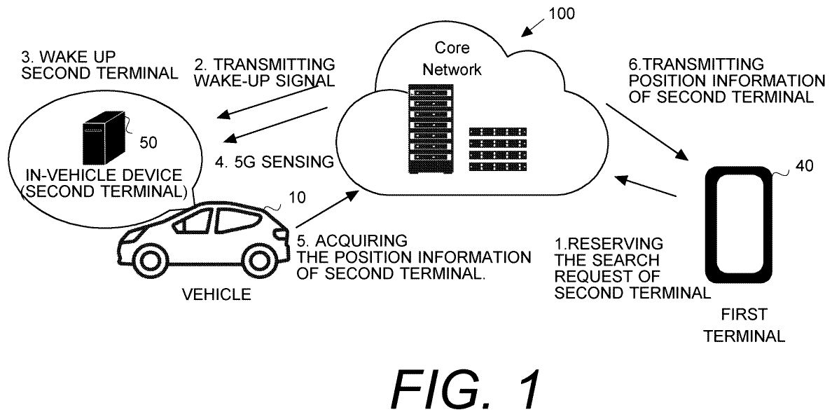

An overview of the system according to the embodiment will be explained with reference to FIG. 1. FIG. 1 is a diagram illustrating an overview of the processing to be executed by the system according to the first embodiment. The system according to one aspect of the present disclosure is realized as a system 100. In the present embodiment, system 100 senses the position of second terminal 50 after transmitting a signal that causes second terminal 50 installed in the vehicle 10, which is a search object, to enter a wake-up state based on a request from first terminal 40 owned by the user.

First, system 100 receives from first terminal 40, a search request of second terminal 50; the search request of second terminal 50 is information requesting that the location information of second terminal 50 be notified. When system 100 receives the search request of second terminal 50, it transmits a wake-up signal to second terminal 50. The wake-up signal is a signal for activating second terminal 50. Based on an identifier of second terminal 50 included in the search request of second terminal 50, system 100 may identify second terminal 50 and transmit a wake-up signal or broadcast said wake-up signal.

Next, second terminal 50 that receives the wake-up signal enters a wake-up state (start-up state).

Subsequently, system 100 implements sensing of the position with respect to second terminal 50 in the wake-up state. For example, system 100 acquires latitude and longitude information and altitude information of second terminal 50. System 100 transmits the acquired position information of second terminal 50 to first terminal 40.

As described above, when system 100 receives the search request of second terminal 50, it transmits a wake-up signal for activating second terminal 50; and system 100 carries out sensing of the position with respect to second terminal 50 in the activated state. With the implementation of sensing, system 100 acquires position information of second terminal 50 and transmits it to first terminal 40.

This enables system 100 to acquire information indicating the position of second terminal 50 that is the terminal to be searched. For example, first terminal 40, which has acquired the position information of second terminal 50 from system 100, may display a line indicating the path to second terminal 50 in an image representing the surroundings of first terminal 40 in an Augmented Reality (AR). According to such a configuration, system 100 may be able to realize a specific guidance display of the path from the position of first terminal 40 that is the user's current position to the position of second terminal 50 that is the terminal to be searched.

### [System Structure]

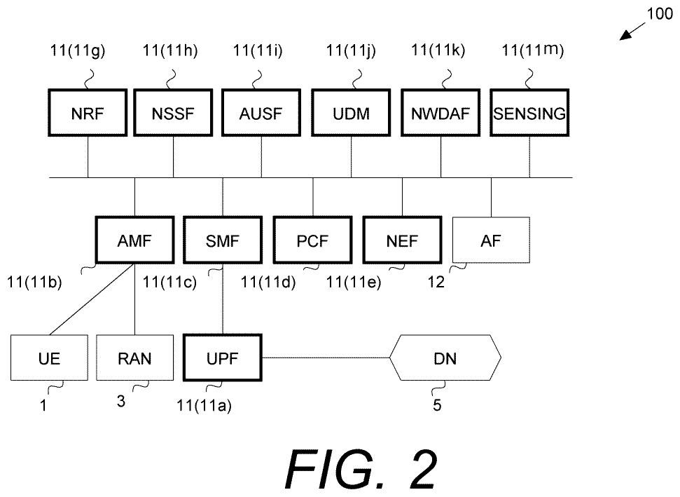

FIG. 2 illustrates the components that constitute a fifth-generation mobile communication system (5G network). In FIG. 2, UE (User Equipment) 1 is a terminal of a user (subscriber). In this embodiment, UE 1, which is a terminal owned by the user, is referred to as “first terminal 40”, and UE 1, which is an in-vehicle terminal, is referred to as “second terminal 50”. RAN (Radio Access Network) 3 is an access network to the 5G core network (5GC). RAN 3 is composed of base stations (gNB). The 5G network consists of the 5G core network (5GC) and access network ((R)AN), and in the 5G network, UE1, DN5, and AF12 are connected. Each of NF11a to 11m is a function realized by one or more computers (information processing apparatuses) executing a program. However, a single computer may realize any two or more of NF11a to 11m. Each of NF11a to 11m can also be called a network node or network component. The components (elements) illustrated in FIG. 1 realize system 100 according to the embodiment.

The 5GC is composed of a set of components including a predetermined function called NF (Network Function). In FIG. 1, the following is illustrated as the NF 11 constituting the 5GC. In FIG. 1, a plurality of elements constituting the NF 11 are shown in the form of bold lines.
UPF (User Plane Function) 11a
AMF (Access and Mobility Management Function) 11b
SMF (Session Management Function) 11c
PCF (Policy Control Function) 11d
NEF (Network Exposure Function) 11e
NRF (Network Repository Function) 11g
NSSF (Network Slice Selection Function) 11h
AUSF (Authentication Server Function) 11i
UDM (Unified Data Management) 11j
NWDAF (Network Data Analytics Function) 11k
SENSING (Sensing Function) 11m

UPF 11a executes routing and forwarding of user packets (user plane packets transmitted and received by UE 1), packet inspection, and QoS processing.

AMF11b is an apparatus for accommodating UEs in the 5GC. AMF11b accommodates RAN3 and executes subscriber authentication control, location (mobility) management of UE1, and the like.

SMF11c manages the protocol data unit (PDU) session and controls UPF11A for implementation of quality of service (QOS) control and policy control. PDU session is a virtual communication channel for exchanging data between UE 1 and Data Network (DN). DN5 is a 5GC external data network (internet, etc.).

PCF11d, under the control of SMF11c, executes QoS control, policy control, charging control, and so on. In QoS control, control over communication quality such as prioritized packet forwarding is executed. In policy control, communication controls such as QoS based on network or subscriber information, packet forwarding permission, and charging are executed.

NEF11e serves to mediate communication between the external node and the node in the control plane.

NRF11g stores and manages information on NFs (e.g., AMF, SMF, UPF, etc.) in the 5 GC. NRF11g can reply to an inquiry source with a plurality of NF candidates for inquiries in relation to NFs that it wishes to use.

NSSF11h includes the function of selecting a network slice used by the subscriber from among the network slices generated by the network slicing. The network slice is a virtual network corresponding to the specification according to the application.

AUSF 11i is a subscriber authentication server that executes subscriber authentication under the control of AMF 11b.

UDM 11j retains subscriber-related information and provides subscriber information, or acquires, registers, deletes, and changes the status of UE 1.

NWDAF11k has a function to collect and analyze data from each NF11 and external servers. It is an NF that provides network analysis information.

SENSING11m executes a sensing service that includes collecting sensing information from UE 1, RAN 3 (base station (gNB)) and other nodes and providing the collected sensing information to UE 1 or other external system (AF12, DN5, etc.). The details of SENSING11m will be explained later.

AF 12 is an NF that provides application services via NRF 11g as part of 5GC, or an NF that is external to 5GC and provides application services via NEF 11e. AF 12 executes, for example, processing using sensing data. As an example, AF 12 notifies first terminal 40 of the position of second terminal 50 to be searched acquired by SENSING 11m. The application program executed by first terminal 40 may also operate as AF 12.

In 5GC, multiple NFs of the same type may be prepared. For example, NFs 11 may be prepared for each data center (post office). In addition, one NF 11 may be shared between data centers. In addition, in one data center, multiple NFs of the same type may be configured. The number of data centers and the number of NFs 11 may be set accordingly.

### <Configuration of Information Processing Apparatus and Terminal>

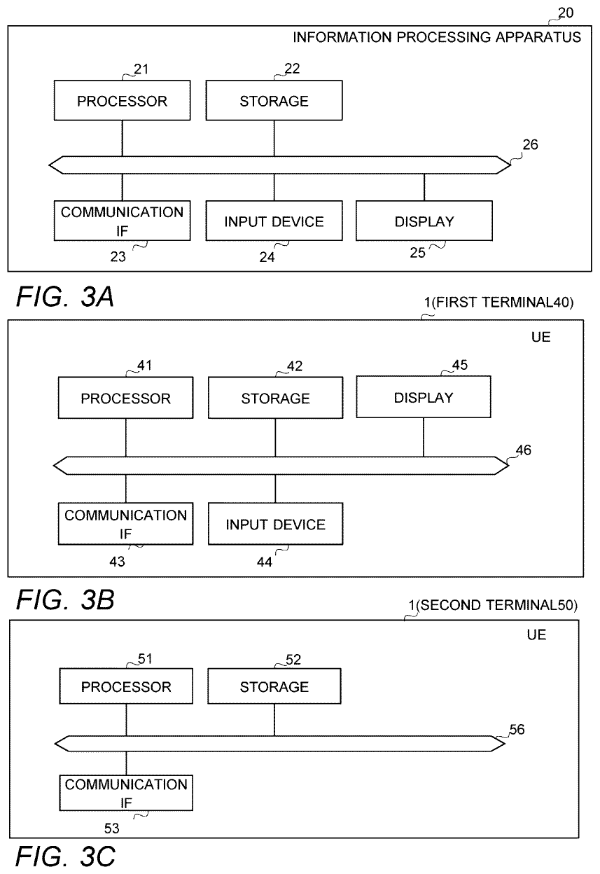

FIG. 3A is a diagram illustrating an example configuration of the information processing apparatus 20 operable as each component constituting system 100 (5G communication system) according to the embodiment. FIG. 3A, the information processing apparatus 20 can be configured using a dedicated or general-purpose information processing apparatus (computer) such as a personal computer (PC), a workstation (WS), or a server machine. However, the information processing apparatus 20 may be a collection of one or more computers (cloud).

The information processing apparatus 20 includes processor 21 as a processing unit or a control unit (controller) connected to each other by means of bus 26, Storage 22, Communication interface 23 (Communication IF 23), Input device 24 and Display 25.

Storage 22 includes a main storage device and an auxiliary storage device. The main storage device is used as at least one of a storage area of program and data, a deployment area of program, a work area of program, and a buffer area of communication data. The main storage device consists of RAM (Random Access Memory) or a combination of RAM and ROM (Read Only Memory). The auxiliary storage device is used as a storage area of data and program. A non-volatile storage medium is applied to the auxiliary storage device. The non-volatile storage medium may be, for example, a hard disk, a Solid State Drive (SSD), a flash memory, or an Electrically Erasable Programmable Read-Only Memory (EEPROM). Further, Storage 22 may include a drive device of the disk recording medium.

Communication IF 23 is a circuit that executes communication processing. For example, Communication IF 23 is a network interface card (NIC). Further, Communication IF 23 may be a wireless communication circuit that executes wireless communication (5G, wireless LAN (Wi-Fi® registered trademark), BLE, etc.). Further, Communication IF 23 may be a combination of a circuit that executes wired communication processing and a wireless communication circuit.

Input device 24 includes a key, a button, a pointing device, and a touch panel, and is used to input information. Display 25 is, for example, a liquid crystal display, and displays information and data.

Processor 21 executes various processing by executing various programs stored in Storage 22. By Processor 21 executing the program stored in Storage 22, the information processing apparatus 20 can operate as each of NFs 11a-11m, external servers 12a and 12b. Processor 21 is a specific example of a controller of system 100.

FIG. 3B is a diagram illustrating a configuration example of first terminal 40, which is a terminal operable as UE 1. First terminal 40 includes a processor 41, Storage 42, Communication interface 43 (Communication IF 43), Input device 44, and Display 45 that are connected to each other by means of bus 46. Processor 41, Storage 42, Communication IF 43, Input device 44, and Display 45 can use something similar to Processor 21, Storage 22, Communication IF 23, Input device 24, and Display 25. For this, these explanations will be omitted.

Processors 21 and 41 are, for example, a Central Processing Unit (CPU). The CPU is also called a microprocessor unit (MPU). Processors 21 and 41 may be a single processor configuration or a multiprocessor configuration. Further, a single physical CPU connected by a single socket may have a multi-core configuration. Processors 21 and 41 may include computing devices of various circuit configurations, such as a Digital Signal Processor (DSP), or a Graphics Processing Unit (GPU). Further, Processors 21 and 41 may include a configuration that cooperates with at least one such as an integrated circuit (IC), other digital circuits, and analog circuits. The integrated circuit includes an LSI, an Application Specific Integrated Circuit (ASIC), and a programmable logic device (PLD), etc. The PLD includes, for example, a Field-Programmable Gate Array (FPGA). Processors 21 and 41 may also include, for example, microcontrollers (MCU), system-on-a-chip (SoC), system LSIs, or chipsets.

FIG. 3C is a diagram illustrating a configuration example of second terminal 50 operable as UE 1. The second terminal 50 includes Processor 51, Storage 52, and Communication interface 53 (Communication IF 53) connected to each other by means of bus 56. Processor 51, Storage 52, and Communication IF 53 can be used in the same manner as Processor 21, Storage 22, and Communication IF 23. For this, these explanations will be omitted.

### [Processing the System]

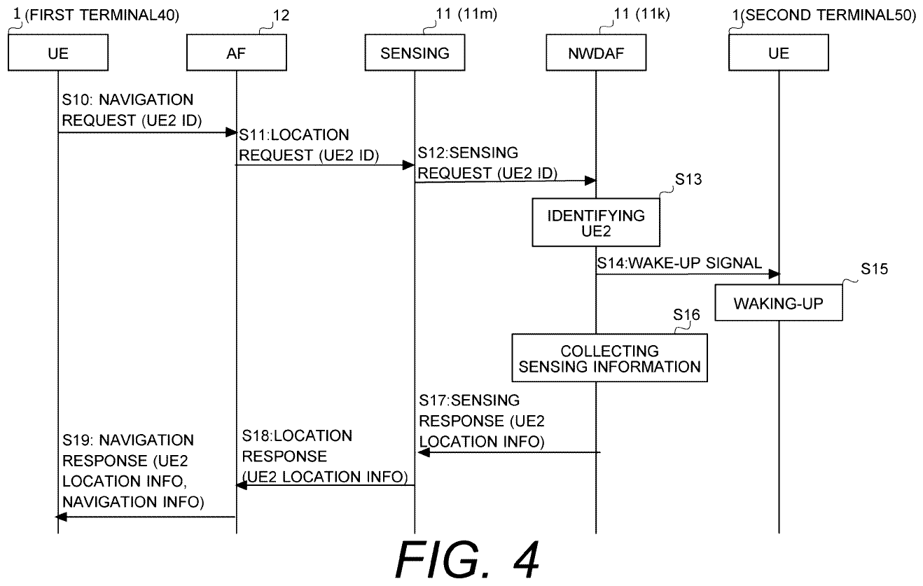

Next, a specific content of the processing to be executed by system 100 according to an aspect of the present disclosure will be explained. FIG. 4 is a sequence diagram illustrating a processing executed by system 100 according to the first embodiment. FIG. 4 illustrates a processing in which system 100 remotely activates second terminal 50 and then senses second terminal 50.

First terminal 40 starts step S10 when the user performs a predetermined operation on first terminal 40.

First, in step S10, first terminal 40 transmits information to AF 12 requesting route guidance to the position of second terminal 50. First terminal 40 includes an identifier for identifying second terminal 50 in the information requesting route guidance. Note that the information requesting route guidance is a specific example of the search request and is information requesting to search for the position of second terminal 50.

In step S11, AF 12 transmits an acquisition request that is information requesting SENSING 11m to acquire the position information of second terminal 50. The acquisition request includes an identifier for identifying second terminal 50.

Next, in step S12, SENSING 11m sends an implementation request requesting NWDAF 11k to implement sensing of the position of second terminal 50. The implementation request includes an identifier for identifying second terminal 50.

Subsequently, in step S13, NWDAF11k identifies second terminal 50 based on an identifier for identifying second terminal 50.

Next, at step S14, NWDAF 11k transmits a wake-up signal for activating second terminal 50 to second terminal 50 specified in step S13. Note that the wake-up signal is a specific example of the first signal.

In step S15, second terminal 50 that receives the wake-up signal enters the activation state.

Next, in step S16, NWDAF 11k executes position sensing for second terminal 50 that has entered the activated state. NWDAF 11k collects sensing information including position information of second terminal 50.

Subsequently, in step S17, NWDAF 11k transmits to SENSING 11m an implementation response that is information including an implementation result of the sensing. The implementation response includes location information of second terminal 50. The position information of second terminal 50 may be, for example, latitude and longitude information and altitude information.

Next, in step S18, SENSING 11m transmits to AF 12 an acquisition response including position information of second terminal 50. The acquisition response includes the position information of second terminal 50 transmitted to SENSING 11m in step S17.

Subsequently, in step S19, AF 12 transmits to first terminal 40 a search response including position information of second terminal 50 and route guidance information to the position of second terminal 50. For example, AF 12 may calculate and transmit a route from the current location of first terminal 40 to the position of second terminal 50 based on information indicating the current location of first terminal 40 received in the search request based on the position information of second terminal 50 received from SENSING 11m.

First terminal 40 may not include an identifier for identifying second terminal 50 in the search request, and in that case, the acquisition request and implementation request may not include an identifier for identifying second terminal 50. If the implementation request does not include an identifier for identifying second terminal 50, NWDAF 11k may broadcast a wake-up signal.

As described above, system 100 according to the first embodiment, upon receiving a request for information from first terminal 40 to search for the position of second terminal 50, sends a signal to activate second terminal 50 and executes location sensing on the activated second terminal 50. Then, system 100 acquires information indicating the position of second terminal 50 and transmits information indicating the position of second terminal 50 to first terminal 40. (Modification of the first embodiment)

The second terminal 50 (UE1) that has been activated in step S15 of the first embodiment may execute sensing of objects around itself. Then, second terminal 50 may transmit the sensing result, which is a result of executing sensing of an object around itself, to NWDAF 11k. NWDAF11k transmits the received sensing result to first terminal 40 via SENSING11m and AF12. First terminal 40 can acquire the result of second terminal 50 executing the sensing and use it for various operations.

For example, when second terminal 50 is a device mounted on the vehicle, information such as what is in the vicinity of the vehicle (auxiliary information for identifying the position of the vehicle) may be acquired and provided to first terminal 40.

### Second Embodiment

In the first embodiment, system 100 senses the position of second terminal 50 in the activated state. On the other hand, it is conceivable that second terminal 50 that has been activated will send its own position information to system 100. Therefore, in the second embodiment, second terminal 50 receives the wake-up signal from system 100 and transmits its own position information to system 100.

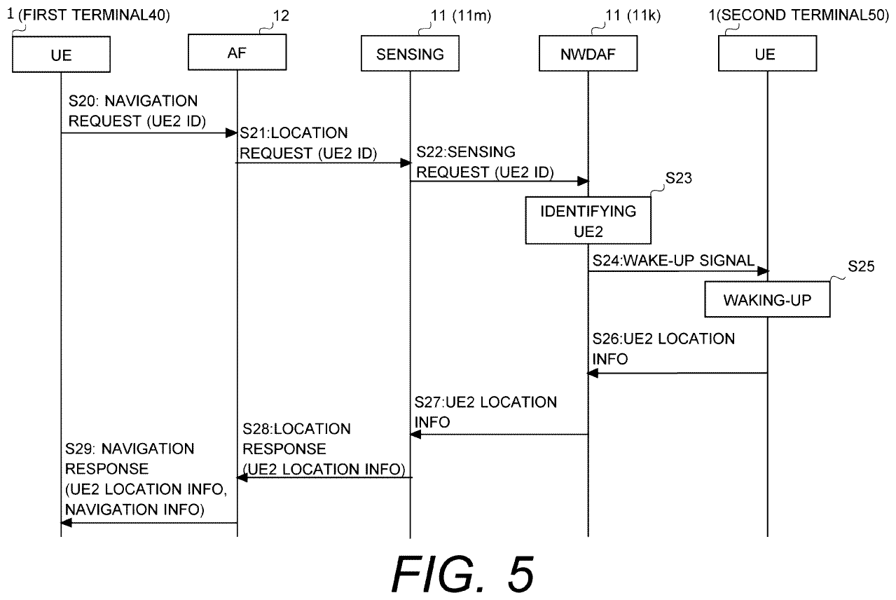

FIG. 5 is a sequence diagram illustrating a processing in which the system according to the second embodiment executes.

UE 1, which is first terminal 40, starts step S20 when the user performs a predetermined operation on first terminal 40.

First, in step S20, first terminal 40 transmits information to AF 12 requesting route guidance to the position of second terminal 50. First terminal 40 includes an identifier for identifying second terminal 50 in the information requesting route guidance. Note that the information requesting route guidance is a specific example of the search request and is information requesting to search for the position of second terminal 50.

In step S21, AF 12 transmits an acquisition request that is information requesting SENSING 11m to acquire the position information of second terminal 50. The acquisition request includes an identifier for identifying second terminal 50.

Next, in step S22, SENSING 11m transmits to NWDAF 11k an implementation request that is a request for sensing the position of second terminal 50. The implementation request includes an identifier for identifying second terminal 50.

Subsequently, in step S23, NWDAF11k identifies second terminal 50 based on an identifier for identifying second terminal 50.

Next, at step S24, NWDAF11k transmits a wake-up signal for activating second terminal 50 to second terminal 50 specified in step S23. Note that the wake-up signal is a specific example of the first signal.

In step S25, second terminal 50 that receives the wake-up signal enters the activation state.

Next, in step S26, second terminal 50 transmits the position information of second terminal 50. For example, second terminal 50 may transmit latitude and longitude information and altitude information of second terminal 50.

Subsequently, in step S27, NWDAF 11k transmits the position information of second terminal 50 received in step S26 to SENSING 11m.

Next, in step S28, SENSING 11m transmits to AF 12 an acquisition response including position information of second terminal 50. The acquisition response includes the position information of second terminal 50 transmitted to SENSING 11m in step S27.

Subsequently, in step S29, AF 12 transmits to first terminal 40 a search response including position information of second terminal 50 and route guidance information to the position of second terminal 50. For example, AF 12 may calculate and transmit a route from the current location of first terminal 40 to the position of second terminal 50 based on information indicating the current location of first terminal 40 received by the search request based on the position information of second terminal 50 received from SENSING 11m.

First terminal 40 may not include an identifier for identifying second terminal 50 in the search request, and in that case, the acquisition request and implementation request may not include an identifier for identifying second terminal 50. If the implementation request does not include an identifier for identifying second terminal 50, NWDAF 11k may broadcast a wake-up signal.

As described above, when system 100 according to the second embodiment receives information from first terminal 40 requesting to search for the position of second terminal 50, it sends a signal to activate second terminal 50, and acquires position information of second terminal 50 from second terminal 50 in the activated state. Then, system 100 transmits information indicating the position of second terminal 50 to first terminal 40.

### Third Embodiment

In the first embodiment, system 100 senses the position of second terminal 50 in the activated state. On the other hand, it is conceivable a form in which second terminal 50 that has been activated periodically transmits a beacon signal informing of its own existence. Therefore, in the third embodiment, the wake-up signal is received from system 100, and second terminal 50 in the activated state periodically transmits the beacon signal itself, and first terminal 40 identifies the position of second terminal 50 based on the beacon signal.

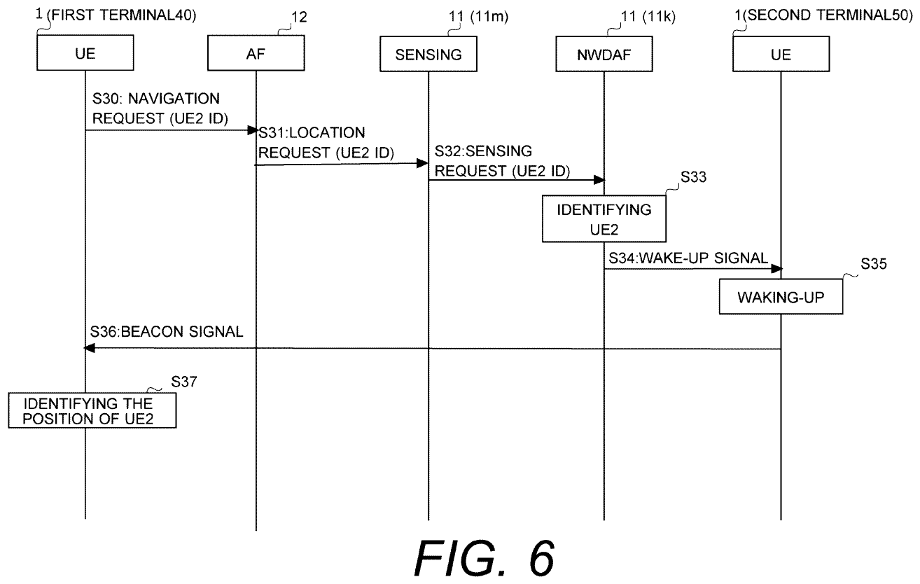

FIG. 6 is a sequence diagram illustrating a processing of executing the system according to the third embodiment.

First terminal 40 starts step S30 when the user performs a predetermined operation on first terminal 40.

First, in step S30, first terminal 40 transmits information to AF12 requesting route guidance to the position of second terminal 50. First terminal 40 includes an identifier for identifying second terminal 50 in the information requesting route guidance. Note that the information requesting route guidance is a specific example of the search request and is information requesting to search for the position of second terminal 50.

In step S31, AF 12 transmits an acquisition request that is information requesting SENSING 11m to acquire the position information of second terminal 50. The acquisition request includes an identifier for identifying second terminal 50.

Next, at step S32, SENSING 11m transmits to NWDAF 11k an implementation request that is a request for sensing the position of second terminal 50. The implementation request includes an identifier for identifying second terminal 50.

Subsequently, at step S33, NWDAF11k identifies second terminal 50 based on an identifier for identifying second terminal 50.

Next, at step S34, NWDAF11k transmits a wake-up signal for activating second terminal 50 to second terminal 50 specified in step S23. Note that the wake-up signal is a specific example of the first signal.

In step S35, second terminal 50 that receives the wake-up signal enters the activation state.

Next, in step S36, second terminal 50 periodically transmits a beacon signal informing of its presence. The beacon signal may include position information of second terminal 50. The position information of second terminal 50 is, for example, latitude and longitude information and altitude information.

Subsequently, at step S37, first terminal 40 identifies the position of second terminal 50 based on the beacon signal received at step S36. For example, first terminal 40 may determine the location of second terminal 50 based on the received signal strength and direction of the beacon signal. Alternatively, when the beacon signal includes position information of second terminal 50, the position of second terminal 50 may be specified based on the position information of second terminal 50.

After step S37, first terminal 40 may transmit position information representing the specified position of second terminal 50 to AF 12 and acquire information from AF 12 about the path from the position of first terminal 40 to a position of second terminal 50.

Further, first terminal 40 may not include an identifier for identifying second terminal 50 in the search request, and in that case, the acquisition request and implementation request may not include an identifier for identifying second terminal 50. If the implementation request does not include an identifier for identifying second terminal 50, NWDAF 11k may broadcast a wake-up signal.

As described above, system 100 according to the third embodiment, transmits a signal to activate second terminal 50 when it receives information from first terminal 40 requesting it to search for the position of second terminal 50. Then, the activated second terminal 50 periodically transmits a beacon signal that first terminal 40 can receive. Then, first terminal 40 that receives the beacon signal identifies the position of second terminal 50.

### Other Modifications

The above embodiment is an example only, and the present disclosure may be implemented with appropriate modifications within a certain range that does not deviate from the abstract. For example, the processes and means described in the present disclosure can be freely combined and implemented as long as there is no technical contradiction.

The present disclosure may also be realized by supplying a computer program that implements the functions described in the above embodiment to a computer and includes one or more processors of the computer read and execute the program. Such a computer program may be provided to the computer by a non-transitory computer-readable storage medium connectable to the system bus of the computer or may be provided to the computer over a network. The non-transitory computer-readable storage medium includes, for example, any type of disk such as magnetic disk (Floppy® disk, hard disk drive (HDD), etc.), optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. A system, for communicating with a first terminal and a second terminal different from the first terminal, comprising a controller comprising at least one processor configured to perform:
receiving, from the first terminal, a search request that is information requesting to search for a position of the second terminal;
transmitting a first signal that is a signal to cause the second terminal to enter a wake-up state when the search request is received;
detecting the position of the second terminal that has entered the wake-up state;
transmitting position information indicating the detected position of the second terminal to the first terminal.

2. The system according to claim 1, wherein the controller receives the position information indicating the position of the second terminal transmitted by the second terminal after entering the wake-up state.

3. The system according to claim 1, wherein the second terminal is an in-vehicle terminal installed in a vehicle, and
the controller causes the second terminal to periodically transmit a beacon signal that the first terminal can receive after the second terminal enters the wake-up state.

4. The system according to claim 1, wherein the controller receives, from the first terminal, ID information indicating an identifier of the second terminal;
identifies the second terminal based on the received ID information and transmits the first signal to the identified the second terminal.

5. The system according to claim 1, wherein the controller receives a sensing result that is a result of sensing of the second terminal in the wake-up state an object surrounding the second terminal, and
further transmits the sensing result to the first terminal.
